(19) United States
(12) Patent Application Publication
(10) Pub. No.: US 2008/0215541 A1
(43) Pub. Date: Sep. 4, 2008

(54) TECHNIQUES FOR SEARCHING WEB FORUMS

(75) Inventors: Hang Li, Beijing (CN); Gu Xu, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/681,165

(22) Filed: Mar. 1, 2007

(51) Int. Cl. G06F 17/30

(52) U.S. Cl. 707/3; 707/E17.108

(57) ABSTRACT

A search system provides various techniques for facilitating information retrieval. The search system may identify alternate queries for an initial query submitted by a user to a search system. Upon receiving the initial query, the search system identifies questions that are related to the initial query and presents to the user the related questions as alternate queries. The search system may also identify messages within a discussion thread that include answers. The search system may also identify an expert relating to the subject of a query by searching through expert profiles containing keywords of discussion threads in which the expert participated.

### BACKGROUND

Many search engine services, such as Google and Overture, provide for searching for information that is accessible via the Internet. These search engine services allow users to search for display pages, such as web pages, that may be of interest to users. After a user submits a search request (also referred to as a “query”) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of base web pages to identify all web pages that are accessible through those base web pages. The keywords of any particular web page can be identified using various well-known information retrieval techniques, such as identifying the words of a headline, the words supplied in the metadata of the web page, the words that are highlighted, and so on. The search engine service may generate a relevance score to indicate how related the information of the web page may be to the search request. The search engine service then displays to the user links to those web pages in an order that is based on their relevance.

Discussion threads are a popular way for people to communicate using the Internet. A particular popular type of discussion thread service is a web forum. A web forum is a web site that allows users of the web site to post information that is available to be viewed by other users of the web site. A discussion thread, such as a newsgroup, allows people to participate in a discussion about a specific topic. A discussion thread is typically initiated when a person creates an initial message directed to a topic and posts the message as a new discussion thread. Other persons can read the initial message and post response messages to the discussion thread. For example, the initial message may pose a question such as “Has anyone encountered a situation where the Acme software product aborts with error number 456?” Persons who want to participate in the discussion can post response messages such as “It happens to me all the time” or “I fixed the problem by reinstalling the software.” Discussion threads typically take the form of a tree structure as sequences of messages branch off into different paths. For example, three different persons can post a response message to the initial message, starting three branches, and other persons can post response messages to any one of those response messages to extend those branches.

Discussion threads may include questions and their answers. For example, a customer support group within a company that sells a certain software product may provide a mechanism for its customers to create and participate in discussion threads relating to the software product. For example, a customer may initiate a discussion thread by posting an initial message that poses a question such as the one mentioned above. That question may be answered by the posting of a response message by another customer or a customer service representative. The corpus of discussion threads of the company may provide a vast amount of knowledge related to problems and concerns that customers may encounter along with appropriate responses (e.g., answers to questions posed).

When a customer wants an answer to a question, the customer may either initiate a new discussion thread or search messages of existing discussion threads that may provide an answer to the customer's question. When searching for an answer within the messages of a corpus of discussion threads, a customer may submit a short query using keywords of the question. For example, the customer may submit the query “error 456” in hopes of finding an answer to the question mentioned above. A search engine may be used to identify those messages that contain keywords matching the query. In many instances, the messages that best match the keywords of the query are the messages that pose a similar question. The response messages may not result in a good keyword match in part because they may not repeat the keywords of the question. The most relevant message to the customer, however, may be a response message that answers the question, rather than a message that poses a similar question.

### SUMMARY

A method and system for identifying alternate queries for an initial query submitted by a user to a search system is provided. The search system receives an initial query from a user. Upon receiving the initial query, the search system identifies questions that are related to the initial query. The search system may identify various queries from a question store that contains questions identified from discussion threads or from queries submitted by users of a search engine. The search system may then rank the related questions based on their similarity to the initial query using a variety of metrics such as those described above. The search system then presents the ranked questions to the user as suggested alternate queries to the initial query. When a user selects one of the alternate queries as a final query, the search system searches for documents (e.g., messages of a discussion thread or a web page) that match the query. The search system then presents the matching documents to the user as the search results.

The search system may identify messages within a discussion thread that include answers. The search system identifies candidate messages of a discussion thread that are submitted by a person other than the initiator of the discussion thread. The search system then removes as candidate messages those messages that can be identified as very likely to not be an answer. The search system may train a support vector machine to classify messages as being not answers using the training data of the sample posts along with an indication of whether each message is an answer or not. The search system then ranks the remaining candidate messages based on a likelihood of the message being the best answer. The search system may use the determination that a message is an answer when providing search results to a query.

The search system may also identify an expert relating to the subject of a query. The search system may identify experts from among persons who have given answers in a discussion thread. The search system then creates an expert profile for each expert. An expert profile is a collection of keywords (e.g., from questions that the expert answers) that relate to the discussion threads in which the expert participated. When a user wants to identify an expert, the user submits a query to the search system. The search system may use conventional search techniques to identify expert profiles the best match the query. The search system then presents the experts associated with the best matching expert profiles to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the search system in one embodiment.

FIG. 2 is a flow diagram that illustrates the processing of the crawl web forum component of the search system in one embodiment.

FIG. 3 is a flow diagram that illustrates the processing of the identify answer component of the search system in one embodiment.

FIG. 4 is a flow diagram that illustrates the processing of the create expert profiles component of the search system in one embodiment.

FIG. 5 is a flow diagram that illustrates the processing of the search forum component of the search system in one embodiment.

FIG. 6 is a flow diagram that illustrates the processing of the identify alternate queries component of the search system in one embodiment.

FIG. 7 is a flow diagram that illustrates the processing of the identify expanded queries component of the search system in one embodiment.

FIG. 8 is a flow diagram that illustrates the processing of the identify related questions component of the search system in one embodiment.

FIG. 9 is a flow diagram that illustrates the processing of the rank related questions component of the search system in one embodiment.

### DETAILED DESCRIPTION

A method and system for identifying alternate queries for an initial query submitted by a user to a search system is provided. In one embodiment, the search system receives an initial query from a user. For example, the query may be submitted by a user searching for an answer to a question within a web forum or searching for web pages that are related to the query. Upon receiving the initial query, the search system identifies questions that are related to the initial query. The search system may identify various queries from a question store that contains questions identified from discussion threads or from queries submitted by users of a search engine. The search system may use various techniques for identifying whether a question is related to or matches a query. For example, the search system may use a cosine similarity metric, an edit distance metric, a language model-based metric, and so on. The search system may then rank the related questions based on their similarity to the initial query using a variety of metrics such as those described above. The search system then presents the ranked questions to the user as suggested alternate queries to the initial query. When a user selects one of the alternate queries as a final query, the search system searches for documents (e.g., messages of a discussion thread or a web page) that match the query. The search system then presents the matching documents to the user as the search results. In this way, the search system suggests alternate queries to a user that are derived from the corpus of documents of interest and thus may more likely identify documents of interest to the user.

In one embodiment, the search system may use expanded queries of the initial query to search for related questions. Upon receiving an initial query, the search system may expand any acronyms of the initial query. Then, for each word of the initial query, the search system may correct any misspelling of the word, perform stemming on the word, and identify synonyms of that word. For example, if the query is “displaing icons,” the search system may correct the spelling to “displaying,” stem the word to “display,” and identify the synonyms of “render,” “output,” and “show.” The search system may then generate the expanded queries of “render icon,” “output icon,” and “show icon.” The search system searches for questions that are related to each expanded query and considers the related questions to also be related to the initial query. The search system then ranks and presents the related questions to the user as alternate queries as described above. In an alternate embodiment, the search system may perform the searching for and presenting of alternate queries as the user types a query. For example, each time a user enters a new letter or completes a word of the initial query, the search system may update a list of alternate queries that is presented to the user. At any time, the user may select an alternate query from the list as the final query.

In one embodiment, the search system treats the identification of alternate queries as a “translation” from one language to another language. The search system thus may employ a source-channel model used in such translations to identify questions that are related to a query (e.g., initial query or expanded query). In particular, the search system may select according to the following equation:

$${arg max}_{y} P ( y \vert x ) = {arg max}_{y} P ( y ) P ( x \vert y )$$

where P(y|x) is the conditional probability of query x given question y, P(y) is the probability of question y, and P(x|y) is the conditional probability of question y given query x. P(y) corresponds to a language model, and P(x|y) corresponds to a translation model. The search system creates a language model using a corpus of documents and estimates the bigram probabilities (e.g., P(mining|data) and P(book|mining)). The search system may use various smoothing techniques to account for sparse data in the corpus. The search system builds a translation model using merging (e.g., “book store” to “bookstore”), splitting (e.g., “Patentand Trademark Office” to “Patent and Trademark Office”), switching (e.g., “mining data” to “data mining”), and replacing (e.g., “data mine” to “data mining”). The search system may assume that all the translation probabilities are 1. The search system may use various dynamic programming techniques (e.g., a Viterbi algorithm) to identify the most probable translation path within a lattice of paths.

In one embodiment, the search system identifies messages within a discussion thread that include answers. The search system identifies candidate messages of a discussion thread that are submitted by a person other than the initiator of the discussion thread. For example, the initiator of a discussion thread may pose a question that is the subject of the discussion thread. The search system then removes as candidate messages those messages that can be identified as very likely to not be an answer. The search system may train a support vector machine to classify messages as being not answers using the training data of the sample posts along with an indication of whether each message is an answer or not. Alternatively, the search system may use language patterns (e.g., “I have a similar problem”) to identify messages that are very likely not an answer. The search system may also use a Conditional Random Fields (“CRF”) model to label the messages. A CRF model is an undirected graphical model trained to maximize a conditional probability, as described in Lafferty, J., McCallum, A., and Pereira, F., “Conditional Random Fields: Probabilistic Models for Segmenting and Labeling Sequence Data,” ICML 2001. The search system then ranks the remaining candidate messages based on a likelihood of the message being an answer. For example, the search system may train a ranking support vector machine to rank the answer messages. The search system may represent candidate messages for ranking purposes using various features. These features may include length of the candidate message, the total number of messages in the web forum submitted by the submitter of the candidate message, the number of messages of the discussion thread submitted by the submitter of the candidate message, the order in the discussion thread of all messages submitted by the submitter of the candidate message, content heuristics (e.g., number of external links and presence of answer-indicating words or phrases), and so on. The search system may use the determination that a message is an answer when providing search results to a query. For example, the search system may include in the search results only messages that are highly ranked as answers or may rank such messages higher within the search results.

The search system may use various techniques to train the classifier to classify messages as answers or not answers. The classifier may be trained to generate discrete values (e.g., 1 or 0) indicating whether or not a messages is an answer or continuous values (e.g., between 0 and 1) indicating the likelihood that a message is an answer. The search system may use support vector machine techniques to train the classifier. A support vector machine operates by finding a hyper-surface in the space of possible inputs. The hyper-surface attempts to split the positive examples (e.g., features of answer messages) from the negative examples (e.g., non-answer messages) by maximizing the distance between the nearest of the positive and negative examples to the hyper-surface. This allows for correct classification of data that is similar to but not identical to the training data. Various techniques can be used to train a support vector machine. One technique uses a sequential minimal optimization algorithm that breaks the large quadratic programming problem down into a series of small quadratic programming problems that can be solved analytically. (See Sequential Minimal Optimization, at http://research.microsoft.com/˜jplatt/smo.html.)

The search system may use a RankSVM algorithm to rank the candidate messages as answers. A RankSVM algorithm, which is a variation of a generalized support vector machine (SVM), attempts to learn a ranking function that preserves the pairwise partial ordering of the candidate messages of training data. A RankSVM algorithm is an ordinal regression technique to minimize the number of incorrectly ranked pairs. A RankSVM algorithm is described in Joachims, T., “Optimizing Search Engines Using Clickthrough Data,” Proceedings of the ACM Conference on Knowledge Discovery and Data Mining (“KDD”), ACM, 2002. Another example of a technique for learning a ranking function is a RankBoost algorithm. A RankBoost algorithm is an adaptive boosting algorithm that, like a RankSVM algorithm, operates to preserve the ordering of pairs of candidate messages. A RankBoost algorithm attempts to directly solve a preference learning. A RankBoost algorithm is described in Freund, Y., Iyer, R., Schapire, R., and Singer, Y., “An Efficient Boosting Algorithm for Combining Preferences,” Journal of Machine Learning Research, 4, 2003. As another example, a neural network algorithm, referred to as RankNet, may be used to rank candidate messages. A RankNet algorithm also operates to preserve the ordering of pairs of candidate messages and models the ordinal relationship between two documents using a probability. A RankNet algorithm is described in Burges, C., Shaked, T., Renshaw, E., Lazier, A., Deeds, M., Hamilton, N., and Hullender, G., “Learning to Rank Using Gradient Descent,” 22nd International Conference on Machine Learning, Bonn, Germany, 2005.

In one embodiment, the search system identifies an expert relating to the subject of a query. The search system may identify experts from among persons who have participated in a discussion thread. For example, the search system may identify an expert as any person who has submitted more than a certain number of messages within a web forum. Alternatively, the search system may use rating information on messages provided by participants of a discussion thread to identify an expert. The search system then creates an expert profile for each expert. An expert profile is a collection of keywords that relate to the discussion threads in which the experts participated. For example, the search system may identify keywords from all the discussion threads in which an expert participated and add all the identified keywords to the expert profile of that expert. The search system may create an index of keywords to expert profiles to facilitate searching for expert profiles. When a user wants to identify an expert, the user submits a query to the search system. The search system may use conventional search techniques (e.g., a term frequency by inverse document frequency metric) to identify expert profiles that best match the query. The search system may also preprocess the query removing non-keywords from the query to facilitate the searching. The search system then presents the experts associated with the best matching expert profiles to the user.

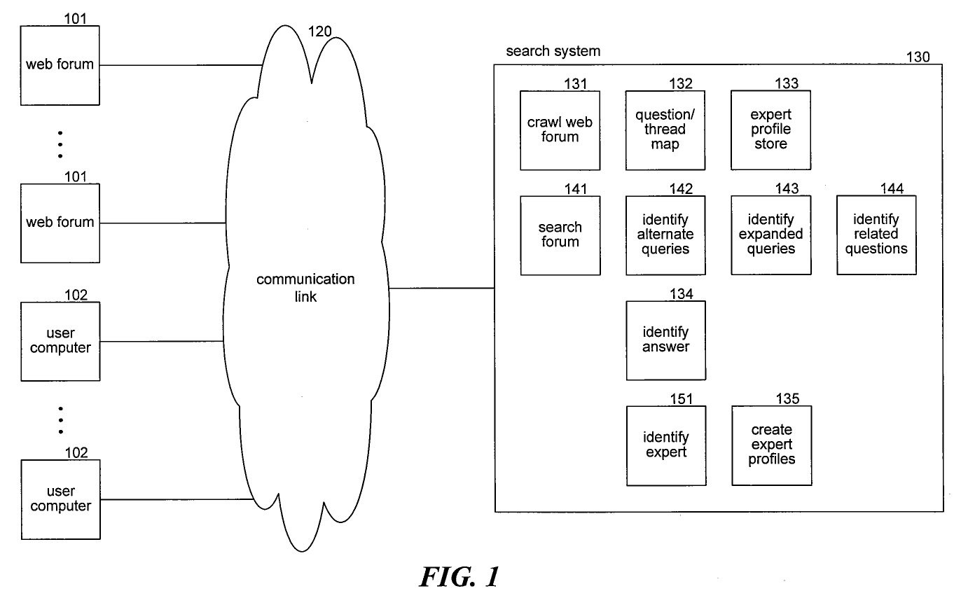

FIG. 1 is a block diagram that illustrates components of the search system in one embodiment. The search system 130 is connected to various web forums 101 and user computers 102 via communications link 120. The search system includes a crawl web forum component 131, a question/thread map 132, an expert profile store 133, an identify answer component 134, and a create expert profiles component 135. The crawl web forum component crawls various web forums to identify questions and their related threads. The crawl web forum component stores an index of the questions and corresponding threads in the question/thread map. The crawl web forum component invokes the identify answer component to identify answer messages within each discussion thread. The crawl web forum component also invokes the create expert profiles component to create the expert profiles and store the profiles in the expert profile store. The search system also includes a search forum component 141, an identify alternate queries component 142, an identify expanded queries component 143, and an identify related questions component 144. The search forum component receives a query from a user and invokes the identify alternate queries component to identify alternate queries for the initial query. The identify alternate queries component invokes the identify expanded queries component to identify expanded queries and the identify related questions component to identify questions related to each expanded query. The search system includes an identify expert component 151 that receives a query from a user and identifies an expert relating to that query based on the information in the expert profile store.

The computing device on which the search system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the search system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the search system may be implemented in various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The search system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, separate computing systems may crawl the web forums, identify answers, identify experts, suggest alternate queries, and train the various classifiers.

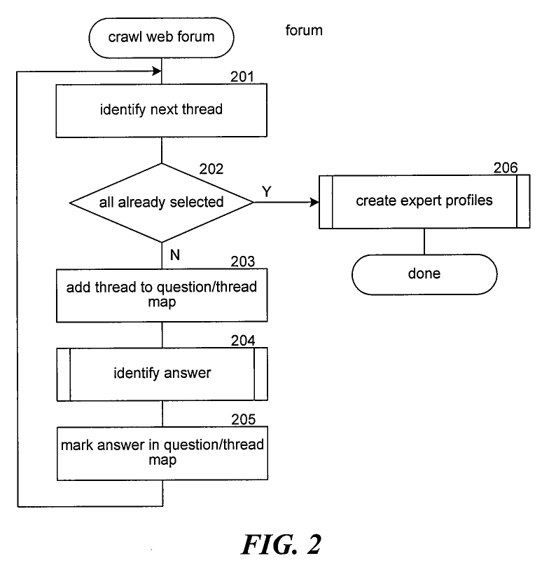

FIG. 2 is a flow diagram that illustrates the processing of the crawl web forum component of the search system in one embodiment. The component is passed an indication of a web forum and identifies the threads of the web forum, identifies answer messages within the threads, and creates the expert profiles. In block 201, the component identifies the next thread of the forum. In decision block 202, if all the threads have already been selected, then the component continues at block 206, else the component continues at block 203. In block 203, the component adds the selected thread to the question/thread map. In block 204, the component invokes the identify answer component to identify answer messages within the identified thread. In block 205, the component marks answer messages within the identified thread and then loops to block 201 to identify the next thread. In block 206, the component invokes the create expert profiles component to create the expert profiles and then completes.

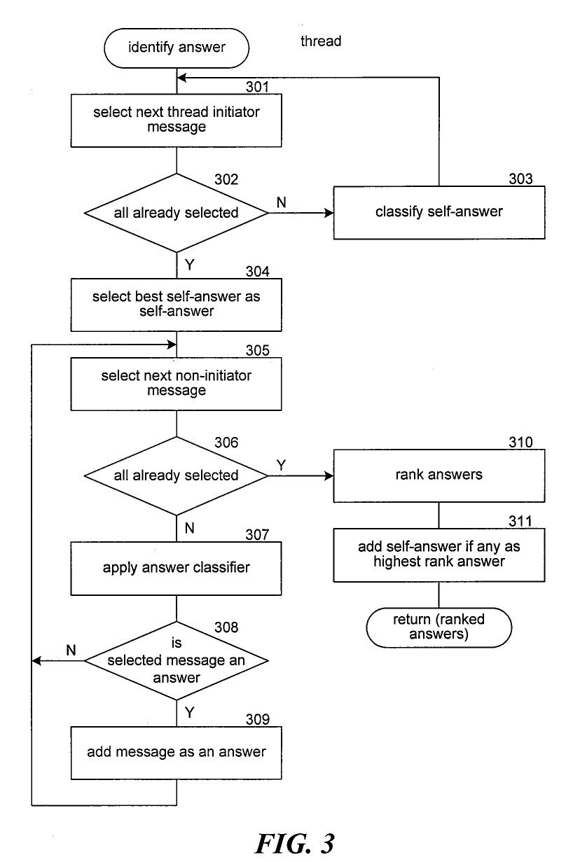

FIG. 3 is a flow diagram that illustrates the processing of the identify answer component of the search system in one embodiment. The component is passed a thread and ranks messages of the thread that may be answers. In blocks 301-303, the component loops identifying whether any messages submitted by the initiator of the thread include an answer to the question of the thread. Such messages are considered “self-answers” in that the initiators are answering their own questions. In block 301, the component selects the next message of the thread submitted by the initiator. In decision block 302, if all such messages have already been selected, then the component continues at block 304, else the component continues at block 303. In block 303, the component classifies the selected message as being a self-answer or not. The component then loops to block 301 to select the next message. The component may classify a message as a self-answer using various types of classifiers that have been trained or may use a rule-based system. In block 304, the component selects the best self-answer message as the self-answer message. In blocks 305-309, the component loops identifying answers within messages submitted by others than the initiator. In block 305, the component selects the next message submitted by a non-initiator. In decision block 306, if all such messages have already been selected, then the component continues at block 310, else the component continues at block 307. In block 307, the component applies an answer classifier to classify the message as an answer or not. In decision block 308, if the selected message is classified as an answer, then the component continues at block 309, else the component loops to block 305 to select the next message submitted by a non-initiator. In block 309, the component adds the message as an answer and then loops to block 305 to select the next message submitted by a non-initiator. In block 310, the component ranks the answers. In block 311, the component adds the self-answer, if any, as the highest ranking answer and then returns the ranked answers.

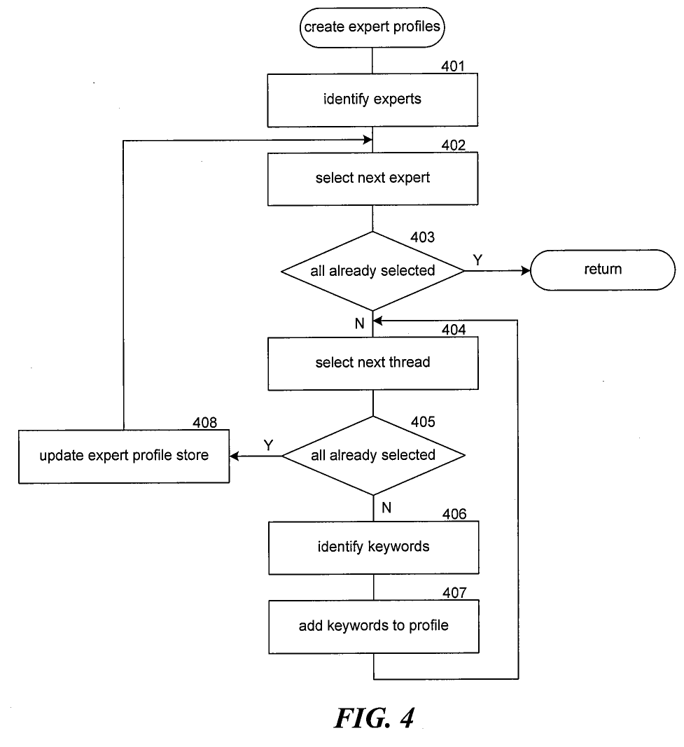

FIG. 4 is a flow diagram that illustrates the processing of the create expert profiles component of the search system in one embodiment. In block 401, the component identifies experts from among persons who have participated in the discussion threads of a web forum. In blocks 402-408, the component loops creating an expert profile for each identified expert. In block 402, the component selects the next expert. In decision block 403, if all the experts have already been selected, then the component returns, else the component continues at block 404. In blocks 404-407, the component loops extracting keywords from each thread in which the selected expert participated. In block 404, the component selects the next thread in which the selected expert participated. In decision block 405, if all such threads have already been selected, then the component continues at block 408, else the component continues at block 406. In block 406, the component identifies keywords of the selected thread. Alternatively, the component may select keywords only from messages of the thread submitted by the selected expert or weight such keywords more heavily than keywords of other messages. In block 407, the component adds the keywords to the expert profile of the selected expert and loops to block 404 to select the next thread. In block 408, the component updates the expert profile store by adding the expert profile for the selected expert and then loops to block 402 to select the next expert.

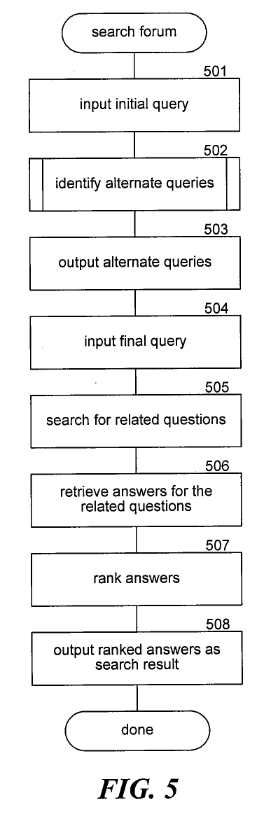

FIG. 5 is a flow diagram that illustrates the processing of the search forum component of the search system in one embodiment. In block 501, the component inputs an initial query from a user. In block 502, the component invokes the identify alternate queries component to identify the alternate queries for the initial query. In block 503, the component outputs the alternate queries to the user. In block 504, the component inputs a final query from the user. In block 505, the component searches for questions related to the final query. In block 506, the component retrieves the answers for the related questions. In block 507, the component ranks the answers. In block 508, the component outputs the ranked answers as the search results and then completes.

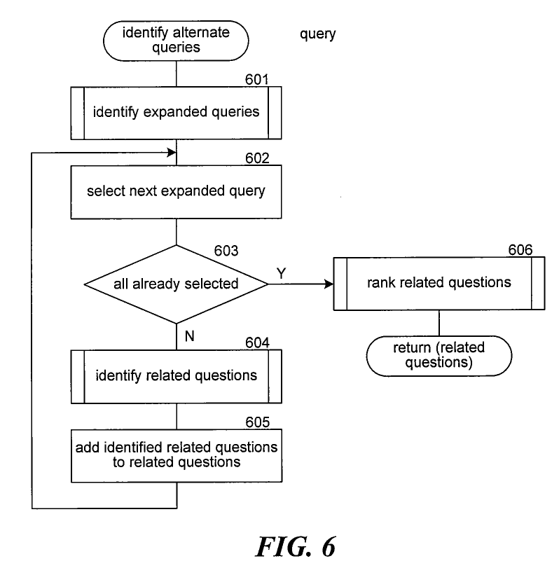

FIG. 6 is a flow diagram that illustrates the processing of the identify alternate queries component of the search system in one embodiment. The component is passed a query and returns related questions as alternate queries. In block 601, the component invokes the identify expanded queries component to identify expansions of the passed query. In blocks 602-605, the component loops identifying questions related to each expanded query. In block 602, the component selects the next expanded query. In decision block 603, if all the expanded queries have already been selected, then the component continues at block 606, else the component continues at block 604. In block 604, the component invokes the identify related questions component to identify questions relating to the selected expanded query. In block 605, the component adds the identified related questions to a collection of questions related to the passed query and then loops to block 602 to select the next expanded query. In block 606, the component invokes the rank related questions component. The component then returns the ranked related questions as alternate queries.

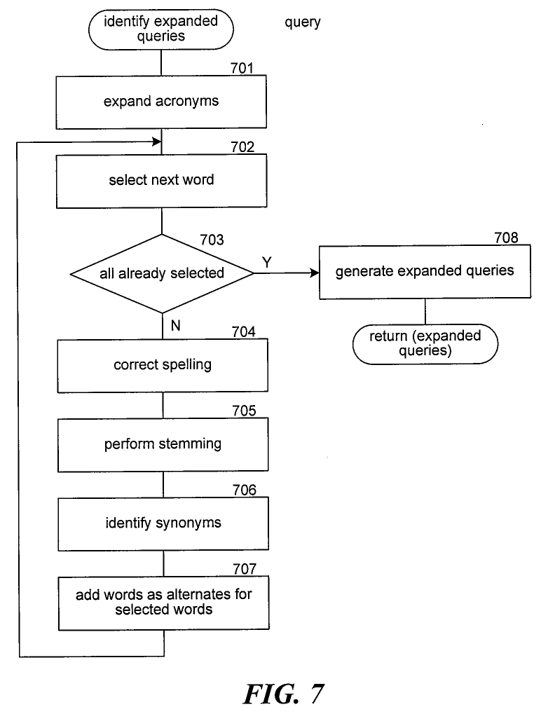

FIG. 7 is a flow diagram that illustrates the processing of the identify expanded queries component of the search system in one embodiment. The component is passed a query and returns expanded queries. In block 701, the component expands any acronyms within the query. In blocks 702-707, the component loops identifying synonyms for each word of the query. In block 702, the component selects the next word of the query. In decision block 703, if all the words have already been selected, then the component continues at block 708, else the component continues at block 704. In block 704, the component corrects any misspelling of the selected word. In block 705, the component performs stemming on the selected word. In block 706, the component identifies synonyms of the selected word. In block 707, the component adds the synonyms as alternatives for the selected word and then loops to block 702 to select the next word of the query. In block 708, the component generates various expanded queries from the synonyms that are alternatives of each word. The component then returns the expanded queries.

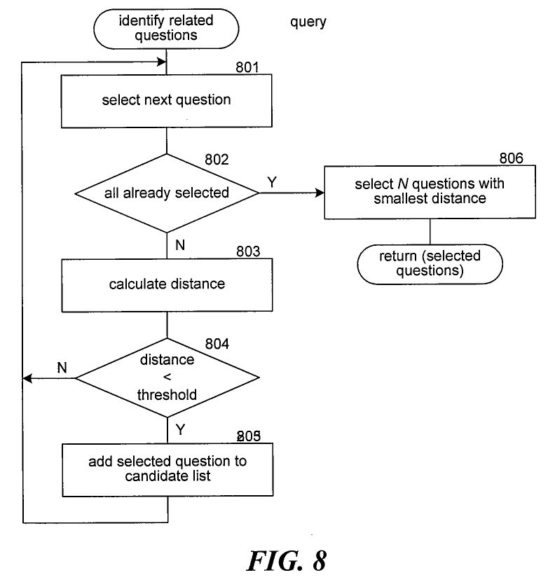

FIG. 8 is a flow diagram that illustrates the processing of the identify related questions component of the search system in one embodiment. The component is passed a query and identifies questions related to that query. In block 801, the component selects the next question. In decision block 802, if all the questions have already been selected, then the component continues at block 806, else the component continues at block 803. In block 803, the component calculates the distance between the selected question and the query. In decision block 804, if the distance is less than a threshold, then the component considers that the query is related to the question and continues at block 805, else the component loops to block 801 to select the next question. In block 805, the component adds the selected question to a candidate list of questions and then loops to block 801 to select the next question. In block 806, the component selects a certain number of questions with the smallest distance from the candidate list of questions. The component then returns the selected questions as the questions related to the query.

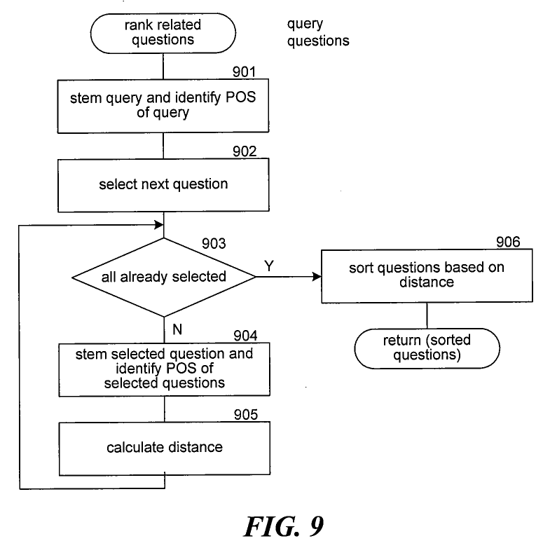

FIG. 9 is a flow diagram that illustrates the processing of the rank related questions component of the search system in one embodiment. The component is passed a query and questions and ranks the questions based on their relatedness to the query. In block 901, the component stems the words of the query and may identify any parts of speech of the words of the query. In blocks 902-905, the component loops calculating the distance between each question and the query. In block 902, the component selects the next question. In decision block 903, if all the questions have already been selected, then the component continues at block 906, else the component continues at block 904. In block 904, the component stems the words of the selected question and identifies the parts of speech of the selected question. One skilled in the art will appreciate that the stemming and the identifying of parts of speech of the question may be performed at the time the question is collected from a web forum. In block 905, the component calculates a distance between the query and the selected question based on a metric that factors in edit distance and the parts of speech. In block 906, the component sorts the questions based on the distance and returns the sorted questions as ranked related questions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A computer system for identifying alternate queries for an initial query, the system comprising:
a component that receives an initial query;
a question store containing questions;
a component that identifies from the question store questions that are related to the initial query; and
a component that indicates that the related questions are potentially alternate queries for the initial query.

2. The computer system of claim 1 including a component that outputs the alternate queries to a user and receives a selection of an alternate query as a final query.

3. The computer system of claim 2 including a component that submits to a search engine the final query, receives from the search engine search results, and outputs the search results to the user.

4. The computer system of claim 1 wherein the questions of the question store are questions of a discussion thread.

5. The computer system of claim 1 wherein the questions of the question store are queries submitted to a web page search engine.

6. The computer system of claim 1 including a component that identifies expanded queries of the initial query and wherein the component that identifies questions identifies questions that are related to each expanded query.

7. The computer system of claim 1 wherein the related questions are ranked based on their similarity to the initial query.

8. The computer system of claim 1 wherein the component that identifies questions selects questions based on a language model-based probability of a corpus of documents relating to the questions.

9. The computer system of claim 8 wherein the questions are queries submitted to a web-based search engine and the corpus includes content identified by search results of the queries.

10. A computer system for identifying an answer within a discussion thread, the computer system comprising:
a component that identifies candidate messages of the discussion thread submitted by persons other than an initiator of the discussion thread;
a component that removes as candidate messages those messages that are identified as likely not being an answer; and
a component that ranks the candidate messages remaining after the removal based on likelihood of being an answer.

11. The computer system of claim 10 including a component that receives a query, searches for discussion threads related to the query, and returns, as search results of the query, messages of the related discussion threads identified as high-ranking answers.

12. The computer system of claim 10 including:
a component that identifies messages of the discussion thread submitted by the initiator of the discussion thread; and
a component that identifies an initiator message as an answer
wherein the component that ranks the candidate messages ranks the initiator message identified as an answer along with the candidate messages.

13. The computer system of claim 12 wherein the initiator message identified as an answer is ranked higher than the candidate messages.

14. The computer system of claim 10 including a component that receives an initial query, identifies from a question store questions that are related to the initial query, outputs to a user the related questions as alternate queries to the initial query, receives a selection of an alternate query as a final query, submits to a search engine the final query, receives from the search engine documents as search results, and outputs to the user messages of the search result.

15. The computer system of claim 10 including a component that identifies messages that are not answers using a support vector machine classifier.

16. The computer system of claim 10 wherein the component that ranks candidate messages ranks using a ranking support vector machine.

17. A computer system for identifying an expert relating to a query, the computer system comprising:
a discussion thread store;
a component that identifies experts from among persons who are participants in discussion threads of the discussion thread store;
a component that creates, for each identified expert, an expert profile having keywords derived from messages of the discussion threads in which the identified expert participated; and
a component that receives a query, searches for an expert profile that matches the query, and indicates that the expert of a matching expert profile is an expert relating to the query.

18. The computer system of claim 17 wherein keywords are identified using a term frequency by inverse document frequency metric.

19. The computer system of claim 17 wherein the component that identifies experts identifies experts based on number of messages submitted by the expert.

20. The computer system of claim 17 wherein the component that searches for an expert profile searches based on keywords of the query.
